(19) United States
(12) Patent Application Publication
(10) Pub. No.: US 2011/0120637 A1
(43) Pub. Date: May 26, 2011

(54) METHOD FOR COATING BOTH SIDES OF A MOLDED PIECE MADE OF RIGID FOAMED MATERIAL

(75) Inventors: Lars Koppelmann, Mannheim (DE); Roland Streng, Frankisch-Crumbach (DE); Joachim Strauch, Mannheim (DE); Peter Kitzel, Ludwigshafen (DE); Markus Salzmann, Lautersheim (DE)

(73) Assignee: BASF SE, Ludwigshafen (DE)

(21) Appl. No.: 12/599,117

(22) PCT Filed: May 5, 2008
(86) PCT No.: PCT/EP2008/055489

§ 371 Date: Nov. 6, 2009

(30) Foreign Application Priority Data
May 8, 2007 (EP) 07107734.1

(51) Int. Cl. B29C 63/20

(52) U.S. Cl. 156/245

(57) ABSTRACT

The invention relates to a process for coating a rigid foam molding on both sides with a plastic film, wherein
a) the molding is arranged and fixed in a spacing ratio between films in a capsule,
b) the air is evacuated from the capsule and
c) the films are as a result pressed onto opposite surfaces of the molding while a reduced pressure is maintained between the films.

The invention relates to a process for coating a rigid foam molding on both sides with a plastic film, wherein
a) the molding is arranged and fixed in a spacing ratio between films in a capsule,
b) the air is evacuated from the capsule and
c) the films are as a result pressed onto opposite surfaces of the molding while a reduced pressure is maintained between the films.

Only one-sided coating processes have been described hitherto in the prior art for the surface treatment of foam moldings after they have been produced (see EP 746 458 and WO 95/23682). If multisided coating is desired, the process has to be repeated a plurality of times. Furthermore, the rigid foam to be coated must, as described in EP 746 458, allow liquids and air to pass through it so that the process can be employed at all. Complete envelopment of the rigid foam moldings is awkward to achieve by means of the processes disclosed in the literature.

Shape, color and surface of foam moldings are difficult or impossible to change subsequently. Appearance and properties such as feel and weathering resistance of the foam moldings, in particular, frequently leave something to be desired.

It was therefore an object of the present invention to discover a process which allows simple subsequent modification of the surface of the foam moldings.

It has now surprisingly been found that the process mentioned at the outset is eminently suitable for carrying out subsequent surface modification of rigid foam moldings.

A comparable process for coating doors is known from WO 01/032400. However, WO 01/032400 does not reveal whether and how foam moldings can be coated by this process.

The process described in WO 01/032400 is expressly incorporated by reference at this point. In particular, reference is expressly made to the following process and apparatus features of WO 01/032400, which are used individually or preferably in combination:
Infrared heating by means of which the plastic film is heated before being pressed on, preferably to above the softening point. Bubble formation, tearing of the film or stress whitening of the film at the edges is thus avoided;
Separate chambers between foam molding and film (chamber A) and between film and capsule wall (chamber B). The chambers A and B are advantageously evacuated simultaneously or preferably in succession. This prevents creasing of the film or premature contact of the film with the foam molding. Breaking of the vacuum in chamber B to atmospheric pressure results in the film being pressed onto the foam molding while the reduced pressure in chamber A is still maintained;
Simultaneous coating of the foam molding with film on opposite sides—this can be achieved, for example, by the foam molding being added in a frame composed of wood, metal or plastic and being held in the middle of the coating chamber by a holder at the top ends of the frame. A further film is placed below the rigid foam molding so as to form a third chamber C between this film and the lower capsule wall. All three chambers are evacuated as described above and the foam molding is, after heating of the film, appropriately coated on both sides by opening of the chambers A and C.
Coating of the plastic film or preferably the foam molding with an adhesive which makes durable adhesion of the film to the foam molding possible.

In the process of the invention for coating a rigid foam molding on both sides with a plastic film,
a) the molding is arranged and fixed in a spacing ratio between films in a capsule,
b) the air is evacuated from the capsule and
c) the films are as a result pressed onto opposite surfaces of the molding while a reduced pressure is maintained between the films.

The process of the invention is surprisingly suitable for two-sided or multisided coating of rigid foams which have hitherto been able to be coated with plastic film only in a number of steps. For the purposes of the present invention, rigid foams are foams in accordance with DIN 7726 (05/1982) which display a relatively high resistance against deformation under a compressive load (compressive stress at 10% deformation or compressive strength in accordance with DIN 53421, 06/1984, ≧80 kPa).

To avoid deformation of the foam molding during the coating process, the molding can be clamped into an auxiliary frame during the entire process.

As adhesives, preference is given to using aqueous polyurethane-based systems, both one-component and two-component systems.

Possible one-component adhesives are PU dispersions, for example Jowapur® 150.50. Possible two-component adhesives are combinations of PU dispersions such as Jowapur® 150.30 with isocyanates such as Jowat® 195.40. However, adhesives based on acrylates or epoxy resins can generally also be used.

Application of the adhesive can be effected by conventional methods such as painting, rolling-on or spraying, with spraying being particularly preferred. A 20 minute drying time at room temperature after application of the adhesive is sufficient in the case of the systems described.

In particular, a two-layer film having a bonding agent based on elastomeric styrene-butadiene block polymers as are described, for example, in WO-A 96/23823 and WO-A 97/46608 is suitable for coating rigid foams by the process of the invention. When the adhesive films mentioned are used, it is generally possible to dispense with the use of an additional adhesive. Preference is given to using coextruded two-layer films comprising a support layer such as polystyrene, HIPS, ASA, polyamide, polypropylene, polyethylene or polyester and a bonding layer comprising an elastomeric thermoplastic such as a styrene-butadiene block polymer as mentioned above.

Rigid foams suitable for producing the foam moldings used according to the invention are, for example, polyurethanes such as Elastopir® or Elastopor® from Elastogran and EPS (expanded polystyrene) from BASF SE. EPS is particularly preferred. These foams are generally closed-celled foams.

The rigid foam substrates to be coated generally have dimensions ranging from DIN A4 format to a number of square meters. The layer thickness of the rigid foams is usually in the range from 50 to 2000 mm.

Closed-celled polyurethane or EPS foams have excellent thermal insulation properties. The low foam density compliments this attractive property profile.

Such closed-celled EPS foams are therefore primarily used in building and transport applications with the objective of saving energy.

The coating applied according to the invention significantly improves the load-bearing capacity and fracture resistance of the rigid foam. This is achieved by the complete removal of air between rigid foam and film, which cannot be brought about by means of conventional lamination processes. Furthermore, application of the reduced pressure presses the film onto the rigid foam, as a result of which a firm bond is obtained between film and rigid foam, which can be strengthened by application of an adhesive.

Absorption of liquid by the foam molding can be virtually completely prevented by coating with a plastic film.

Furthermore, the weathering resistance and the feel of foam moldings can be significantly improved by coating with plastic films.

Finally, the plastic film can function as primer film which allows easy after-treatment such as painting, printing, for example with advertising slogans, etc.

Suitable plastic films are, in particular, polyvinyl chloride, styrene copolymers, polypropylene, polyvinylidene fluoride, thermoplastic polyurethane (TPU) and polymethyl methacrylate (PMMA). Owing to their weathering resistance, styrene copolymers such as SAN, AMSAN and especially ASA have been found to be particularly useful for exterior applications. In the case of, for example, an ASA copolymer, the film can be modified by 0.5-30% by weight of a thermoplastic elastomer. Typical thermoplastic elastomer classes which can be used are: TPE-O (thermoplastic elastomers based on olefins, predominantly PP/EPDM), TPE-V (crosslinked thermoplastic elastomers based on olefins, predominantly PP/EPDM), TPE-U (thermoplastic elastomers based on urethane), TPE-E (thermoplastic copolyesters), TPE-S (styrene block copolymers such as SBS, SEBS, SEPS, SEEPS, MBS) and TPE-A (thermoplastic copolyamides, e.g. PEBA).

Such films can be used either in various single colors or as printed surfaces. In addition, the surface can be structured by means of various embossing rollers during extrusion of the film.

Films such as the abovementioned ASA films can subsequently be altered in terms of color and shape by means of a suitable after-treatment such as painting, printing or embossing. The foams coated with such a primer film can easily be subsequently altered in terms of their appearance and shape.

The films used have a thickness in the range from 50 to 750 μm, preferably from 100 to 500 μm and particularly preferably from 200 to 350 μm. They can be produced from the corresponding starting materials in pellet form by the known processes for film production, with the extrusion process for cast film production being preferred.

To improve the adhesive properties, the films can be subjected to corona treatment either on one side or on both sides.

ASA, polystyrene and HIPS films have been found to be particularly advantageous for coating EPS foams (for example Styropor®). Particularly impact-resistant and fracture-resistant coated rigid foams which are suitable, for example, for pallets can be produced in this way. Furthermore, the coextruded two-layer films described in WO-A 96/23823 and WO-A 97/46608, in particular, can be used for coating EPS foams. The two-layer films comprise a support layer such as ASA, polystyrene or HIPS and a bonding layer based on, for example, elastomeric styrene-butadiene block polymers such as Styroflex® (BASF SE). The use of two-layer films a) ASA support layer (outer skin), for example Luran® (BASF SE), and b) elastomeric styrene-butadiene block polymers, for example Styroflex®, has the advantage that objects which have been coated in this way have very good weathering resistance. As mentioned above, an additional adhesive can usually be dispensed with in these cases. The coextruded film is pressed onto the EPS foam so that the bonding layer comes into direct contact with the EPS foam surface.

Owing to their good thermal insulation properties, the coated foam moldings can advantageously be employed in the building sector.

In particular, the moldings according to the invention can be used as ceiling and wall cladding.

Owing to their low weight and the simple modification of the surface, the foam moldings are also very useful for trade fair construction. Movable walls, room dividers, platform structures can be produced very simply as lightweight constructions.

Owing to their thermal insulation behavior, the attractive surface and their high flexibility, the foam moldings according to the invention are eminently suitable for lamination of, for example, cable shafts, roller blind housings and curtain suspension facilities. The moldings can quickly be adapted to particular requirements by, for example, cutting, bending, etc.

Foams are usually eminently suitable for producing, for example, seats and tables. As mentioned above, an appropriate plastic film such as artificial leather can give an attractive appearance.

However, cladding of the walls of gymnasiums, garages and multistory car parks and also guide barriers is also conceivable. The wall or the guide barrier can be appropriately reinforced at least at the height of a vehicle in order to avoid damage to the vehicle during, for example, parking.

The rigid foams coated with films can advantageously be used as pallets. Compared to pallets produced by the lamination technique, the pallets produced by the process of the invention have a higher load-bearing capacity.

EPS foams are also utilized for packaging or as outer cladding for appliances. Owing to the good thermal insulation properties of the rigid foams, heating pipes and hot water pipes, refrigeration units, refrigerators and freezers, in particular, can be clad with the coated rigid foams produced by the process of the invention.

### USE EXAMPLE

### Example 1

Two-sided coating of Neopolen rigid foam with an ASA film

A rigid foam molding made of Neopolen®, a commercially available foam based on crosslinked polyethylene from BASF SE, was used as substrate to be coated on both sides. The molding was 120 cm long, 80 cm wide and 8 cm high. in the first step, the adhesive was firstly applied. The adhesive used was an aqueous two-component system (consisting of binder and hardener) based on polyurethane which was produced immediately before application by mixing of the two individual components. To obtain a homogeneous mixture, the mixture was stirred at room temperature for at least 3 minutes by means of a precision glass stirrer. The adhesive was subsequently applied in an amount of about 80 g/m² to both surfaces and the 4 edges of the molding by means of a Walther Pilot spray gun. The molding was subsequently allowed to dry at room temperature for 20 minutes. In the next step, the rigid foam molding was fixed by means of a holder at the two top ends (opposite surfaces) and positioned in the middle of the coating capsule. The two plastic films to be applied were in each case arranged between capsule wall and molding. This resulted in 3 chambers in the coating capsule: one chamber between the two plastic films in the middle of which the rigid foam molding was positioned (chamber A). The two other chambers were in each case located between plastic film and capsule wall (chambers B, C). As plastic films, use was made of 250 μm thick, white-pigmented cast films of Luran® S, the ASA copolymer commercially available from BASF SE. All three individual chambers (A, B, C) in the capsule were subsequently evacuated simultaneously. After a reduced pressure of 25 mbar had been reached, the two plastic films were heated to a temperature of 150° C. by means of IR radiators installed at the capsule walls. After the temperature had been reached, heating was stopped and chambers B and C were brought back to atmospheric pressure by means of air, with the reduced pressure in chamber A being maintained. The flooding of chambers B and C resulted in an overpressure which pressed the heated plastic films onto the surfaces and edges of the molding which had been sprayed with adhesive. The two plastic films abutted along the side faces and a weld which ran around the side faces of the entire molding in a frame-like fashion was formed here. This completed the coating process. The heating by means of the IR radiators during the process also activated the adhesive on the top and side faces of the molding, as a result of which very good adhesion between adhesive and plastic film was achieved immediately after the process was complete. After the coating process was concluded, the coated molding could be taken from the capsule. The further film projecting beyond the weld was removed manually by means of a sharp blade.

1. A process for coating a rigid foam molding on both sides with a plastic film, wherein
a) the molding is arranged and fixed in a spacing ratio between films in a capsule,
b) the air is evacuated from the capsule and
c) the films are as a result pressed onto opposite surfaces of the molding while a reduced pressure of less than 30 mbar is maintained between the films.

2. The process according to claim 1, wherein the films divide the capsule into three chambers, with one chamber being located between the films and the air in the other two being removed to the atmosphere in order to bring the films into contact with opposite surfaces of the molding.

3. The process according to either claim 1 or 2, wherein an adhesive is applied to the molding and/or the plastic films before step b).

4. The process according to any of claims 1 to 3, wherein the rigid foam is an EPS foam.

5. The process according to any of claims 1 to 3, wherein the rigid foam is a rigid polyurethane foam.

6. The process according to any of claims 1 to 5, wherein the films are primer films which can easily be after-treated.

7. The process according to any of claims 1 to 5, wherein the films comprise polyvinyl chloride, styrene copolymers, polypropylene, polyvinylidene fluoride, thermoplastic polyurethane and/or polymethyl methacrylate and have a thickness of from 100 to 500 μm.

8. The process according to claim 7, wherein the films comprise two layers: a) a support layer comprising ASA, polystyrene or high-impact polystyrene and b) a bonding layer comprising an elastomeric thermoplastic.

9. The process according to any of claims 1 to 8, wherein the molding is a pallet.

10. The process according to any of claims 1 to 8, wherein the molding is an outer cladding of a housing.
